(19) United States
(12) Patent Application Publication
(10) Pub. No.: US 2011/0012812 A1
(43) Pub. Date: Jan. 20, 2011

(54) Multi View Display

(75) Inventors: Yasuyuki Onda, Kobe (JP); Alex C K Chan, Kobe (JP); Takesh Miyata, Kobe (JP)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: TPO DISPLAYS CORP., Chunan (TW)

(21) Appl. No.: 12/687,420

(22) Filed: Jan. 14, 2010

Related U.S. Application Data
(60) Provisional application No. 61/144,463, filed on Jan. 14, 2009.

(30) Foreign Application Priority Data
Nov. 26, 2009 (JP) 2009268972

(51) Int. Cl. G09G 5/00

(52) U.S. Cl. 345/1.3

(57) ABSTRACT

A multi-view display apparatus that can display the designated partially area as arbitrary objects and background area for each display view by area setting function and display mode selection function in high freedom. The multi-view display apparatus has a display whose display area is divided into a plurality of divided display areas, the divided display areas being visible from respective different view point and each divided display area having at least one partial display area; data generator to generate coordinate data for designating the divided display areas and to generate display mode data to designate display mode in the divided display areas and in the partial display areas; and an allocator to synthesize a plurality of input image data to obtain an synthesized image by allocating the plurality of input image data in views of the divided display area and of the partial display areas in the divided display areas.

### CROSS-REFERENCE TO RELATED APPLICATIONS

This application claims the right of priority based on U.S. provisional Patent Application 61/144,463 entitled “Data Processing for Multi View Display”, filed on Jan. 14, 2009 and Japanese Patent Application 2009-268972 entitled “Multi View Display”, filed on Nov. 26, 2009, which are incorporated herein by reference and assigned to the assignee herein.

### FIELD OF INVENTION

The present invention relates to a multi view display apparatus.

### BACKGROUND OF THE INVENTION

Conventionally, a multi view display apparatus uses such as “slit barrier” technology to provide respective information or images from different viewpoints with only one display.

One example is the multi view display apparatus for a driving navigation system. It provides different information for the driver and the passenger in the front seat. For example, the driver perceives navigation information while the passenger can watch TV. Other example could be referred to Japanese Patent Publication 2007-11061A. Please note that for the convention multi view display apparatus, if an object/image likes to be shown commonly in multiple views, the data of object/image has to be preloaded at multiple image sources.

### SUMMARY OF THE INVENTION

One aspect of the present invention is to provide a multi view display apparatus, particularly a dual view display apparatus, whereby an object/image could be selectively presented in a specified view or presented commonly/concurrently in multiple views, in high freedom.

Another aspect of the present invention is to provide a multi view display apparatus whose display area includes a plurality of divided display area to enable respective information perceived from multiple viewpoints provided by a single display. In addition, the common information could be presently concurrently in the partial display areas in different divided display areas which enable different views.

In one embodiment, disclosed is a multi-view display apparatus has a display whose display area is divided into a plurality of divided display areas, the divided display areas being visible from a plurality of view points and each divided display area having at least one partial display area; a data generator to generate coordinate data for designating the divided display areas and partial display areas in the divided display areas, and display mode data to designate display mode in the divided display areas and in the partial display areas; and an allocator to synthesize a plurality of input image data input to obtain a synthesized image by allocating the plurality of input image data in views of the divided display area and in the partial display areas in the divided display areas.

The above and others objects, features and advantages of the present invention will become more apparent from the following detailed description in conjunction with the accompanying drawings.

### BRIEF DESCRIPTION OF THE DRAWINGS

The invention will now be further described by way of example only with reference to the accompany drawings in which:

FIG. 1 shows a conventional multi view display apparatus;

FIG. 2 shows a multi view display apparatus according to an embodiment of the present invention;

FIG. 3 shows the allocator in the multi view display apparatus illustrated in FIG. 2 according to an embodiment of the present invention;

FIG. 4 shows the functions provided by the function signal generating circuit according to an embodiment of the present invention;

FIGS. 5-9 shows how to specify the divided display area using the area-specific period pulses according to embodiments of the present invention;

FIG. 10 shows the arrangement of the pixels in the LCD display according to embodiments of the present invention;

FIG. 11 shows the R divided display areas for the right view and the L divided display area for the left view corresponding to the pixel arrangement in FIG. 10;

FIG. 12 shows the area-specific period signals from the area-specific period pulse generating circuit according to an embodiment of the present invention;

FIG. 13 shows the synthesis of the RGB signals of Channels A and B according to respective functions, according to an embodiment of the present invention;

FIG. 14 compares the control signal from the image signal selection circuit with the synthesized images according to an embodiment of the present invention;

FIGS. 15-16 shows the left view and the right view provided by the different divided display areas on the same display according to an embodiment of the present invention;

FIG. 17 shows the partial display areas arbitrarily set in the divided display area according to embodiments of the present invention; and

FIG. 18 shows the left view, the right view, and the middle view provided by the different divided display areas on the same display according to an embodiment of the present invention.

### DETAILED DESCRIPTION OF THE PREFERRED EMBODIMENTS

Before showing the embodiments of the present invention, the conventional multi view display technology described in Japanese Patent Publication 2007-11061A is presented for comparison.

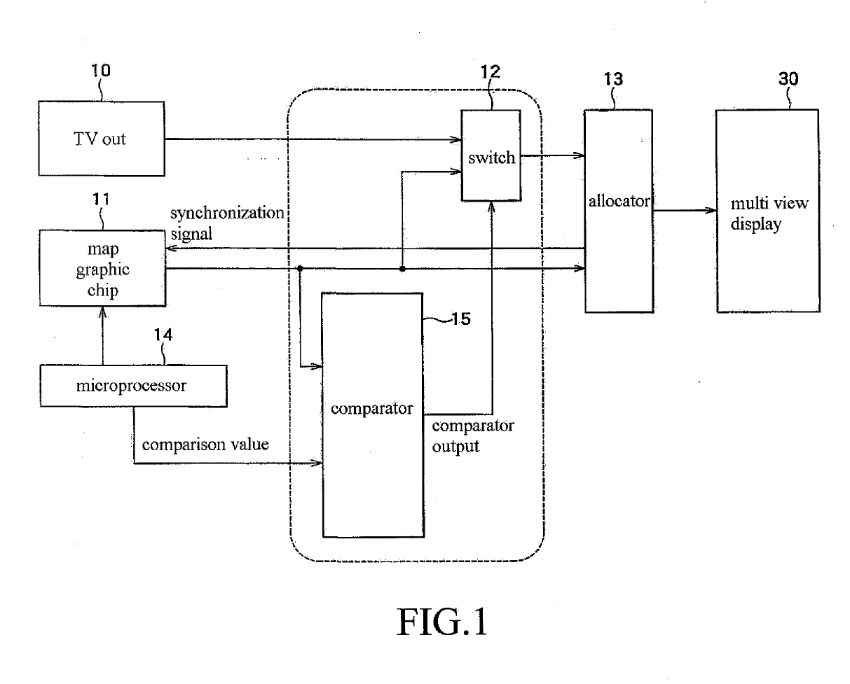

As shown in FIG. 1, the conventional multi view display apparatus has a TV output 10 and a map graphic chip 11 as the image data generator. TV output 10 outputs the received TV broadcast images, or images stored in a DVD or HDD. The map graphic chip 11 is provided in a car driving navigation system for generating navigation map images.

Images of the TV output 10 and the map graphic chip 11 are inputted into the switch 12, and the selected image would be sent to the allocator 13. The output from the map graphic chip 11 and the color reference value provided by the microprocessor 14 are compared by the comparator 15. If the comparison output VSW of the comparator 15 is “high”, they are the same color, and the switch 12 will select images from the map graphic chip 11 and then send to the allocator 13. If the comparison output VSW of the comparator 15 is “low”, they are different colors, and the switch 12 will select images from the TV output 10 and then send to the allocator 13.

Meanwhile, images from the map graphic chip 11 are directly inputted into the allocator 13. The allocator 13 allocates the images from the TV output 10 and the map graphic chip 11 in alternative sub-pixel lines.

The images from the map graphic chip 11 could be presented in the single view or in dual views. But the images from the TV output 10 could be presented in the single view only. Also the data for On Screen Display (OSD) object could be sent to the map graphic chip 11 from the memory of the microprocessor 14. Furthermore the dual views could be left-right exchanged by the allocator 13.

The method mentioned above could only rely on the color comparison to select the OSD object to be commonly (i.e., concurrently) shown in the TV images and the navigation images, i.e., in dual views. And as mentioned above, the image from the TV output 10 could be presented in the single view only. And the OSD object incorporated into the map image could be share, unilaterally only, to the TV image. The object in the TV image cannot share with the map image. More details could be referred to Japanese Patent Publication 2007-11061A.

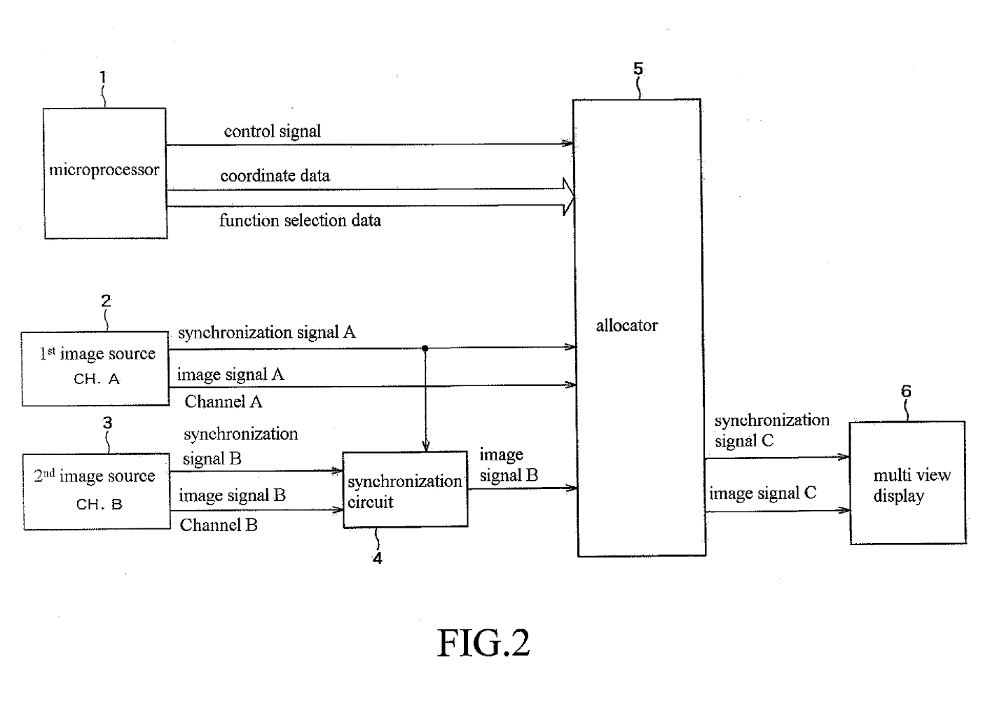

FIG. 2 shows a multi view display apparatus according to an embodiment of the present invention.

The multi view display apparatus has a microprocessor 1, the first image source 2, the second image source 3, the allocator 5, and a multi view display 6. The display 6 provides a display area (e.g., the entire display area) which includes at least two divided display areas. The two divided display areas are visible from respective different viewpoints. The user can do the display setting for a specific part of each divided display area.

The microprocessor 1, functioning as a controller and a data generator, outputs a control signal for the display 6 and data required to perform the data allocation later. The first image source 2 generates an image signal A of Channel A (CH.A) and the synchronization signal A and outputs to the allocator 5; the second image source 3 generates an image signal B of Channel B (CH.B) and the synchronization signal B and outputs to the synchronization circuit 4. The display 6 receives the synchronization signal C and the image signal C from the allocator 5. In addition, the image signals mentioned above could have OSD object data incorporated in advance.

The data outputted from the microprocessor 1 to the allocator 5 includes the function selection data and the coordinate data. The function selection data, as the display mode data, is used to designate the allocation of the image signals for each divided display area, and the coordinate data is to define the start and the end of the divided display area in X-Y coordinates. In one embodiment, the area for showing OSD object/information could be included in the divided display area.

The synchronization circuit 4 takes one of the synchronization signals A and B, (e.g., the synchronization signal A), for reference and performs the synchronization with the other one, say, the synchronization signal B. Then the synchronization circuit 4 sends the image signal B to the allocator 5 based on the synchronization signal B.

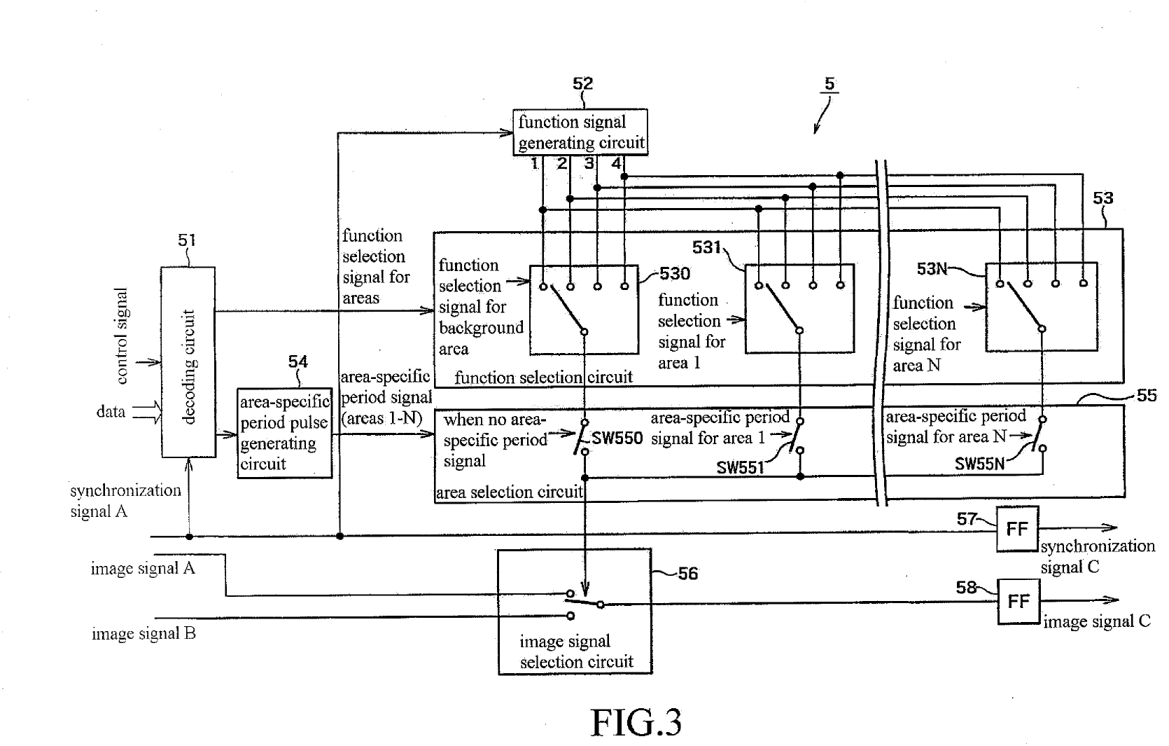

FIG. 3 further shows the allocator 5. The function selection data and the coordinate data from the microprocessor 1 are inputted to the decoding circuit 51. The decoding circuit 51 performs the decoding based on the control signal supplied from the microprocessor 1. Meanwhile, the function selection data for the background display area and the divided display areas are sent to the function selection circuit 53, and the coordinate data are sent to the area-specific period pulse generating circuit 54. As shown, the area-specific period signals for divided display areas 1-N are sent to the area selection circuit 55.

The synchronization signal A is sent to the decoding circuit 51 as well as to the function signal generating circuit 52 for the synchronization of the control signal. The synchronization signal A is also sent to the flip-flop 57 to generate the synchronization signal C and send to the display 6, wherein the flip-flop 57 is provided for timing stabilization.

The function signal generating circuit 52 is to output the function signals to determine the image channels for the left view and the right view.

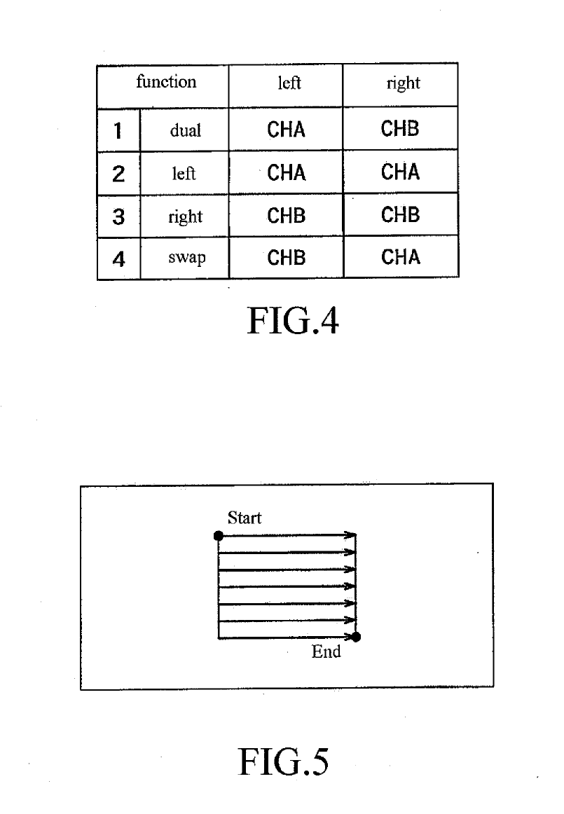

FIG. 4 is a table showing the function signals which designate the display modes, provided by the function signal generating circuit 52. Function 1 is to present the image signal A (CHA) for the left view and the image signal B (CHB) for the right view. This is so called the normal display mode with “dual view”. Function 2 is to present the image signal A (CHA) for the left view and also the image signal A (CHA) for the right view. Function 3 is to present the image signal B (CHB) for the left view and also the image signal B (CHB) for the right view. Functions 2 and 3 present the same image signal for the left and the right views. So they have a “single view”, and it is also called the common display mode. Function 4 is to present the image signal B (CHB) for the left view and the image signal A (CHA) for the right view, i.e., to swap the image signals for the two views in Function 1. Therefore Function 4 could be referred to as the swap display mode with “dual view”.

Back to FIG. 3, the function signals are outputted to the function selection circuit 53. The function selection circuit 53 has selection circuits 530-53N to select the functions for the background display area and the divided display area. In this embodiment, each selection circuit 530-53N has a switch to select one of the four modes/functions provided by the function signal generating circuit 52.

Outputs of Selection circuits 530-53N are inputted to the corresponding switches SW550-55N of the area selection circuit 55. These switches SW550-55N turn ON or Off according to the area-specific period signals from the area-specific period pulse generating circuit 54. For the background display area out of the divided display areas, the switch SW550 could be controlled according to the default setting.

FIGS. 5-9 shows how to specify the divided display area using the area-specific period pulses. As shown in FIG. 5, typically a divided display area is defined by coordinates of the most upper-left and the most bottom-right points.

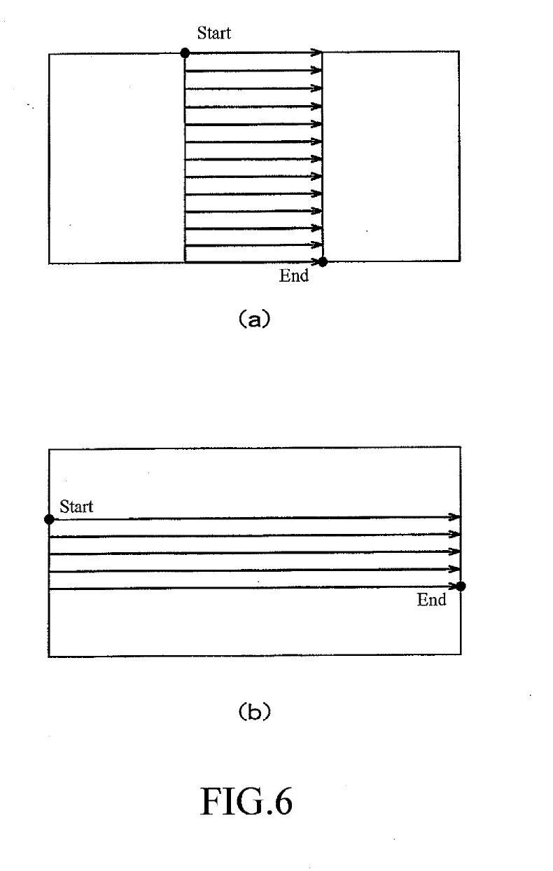

FIGS. 6(a)-(b) shows the strip areas across the entire display, where X direction represents the horizontal direction, and Y direction represents the vertical direction. In FIG. 6(a), the area extends across in Y direction could be defined by only the start and the end in X coordinate. Likewise, in FIG. 6(b), the area extends across in X direction could be defined by only the start and the end in Y coordinate.

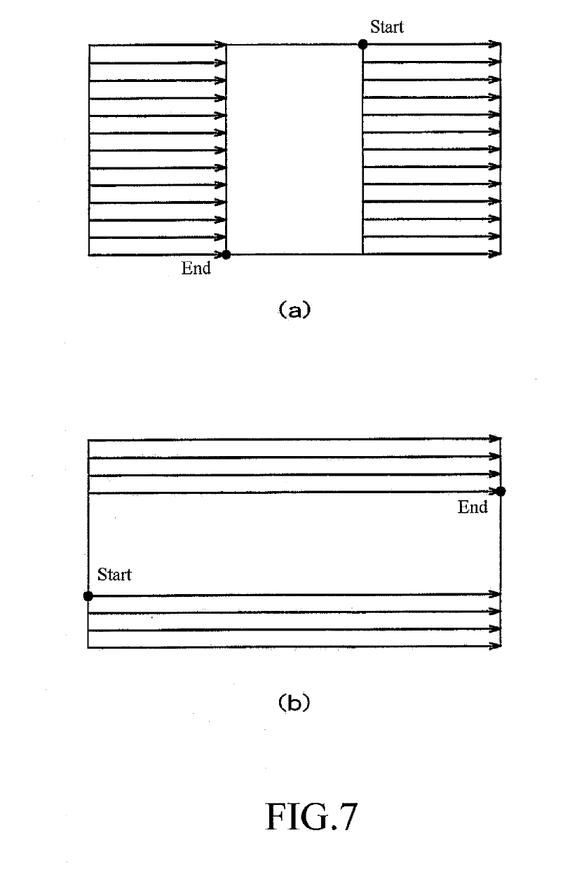

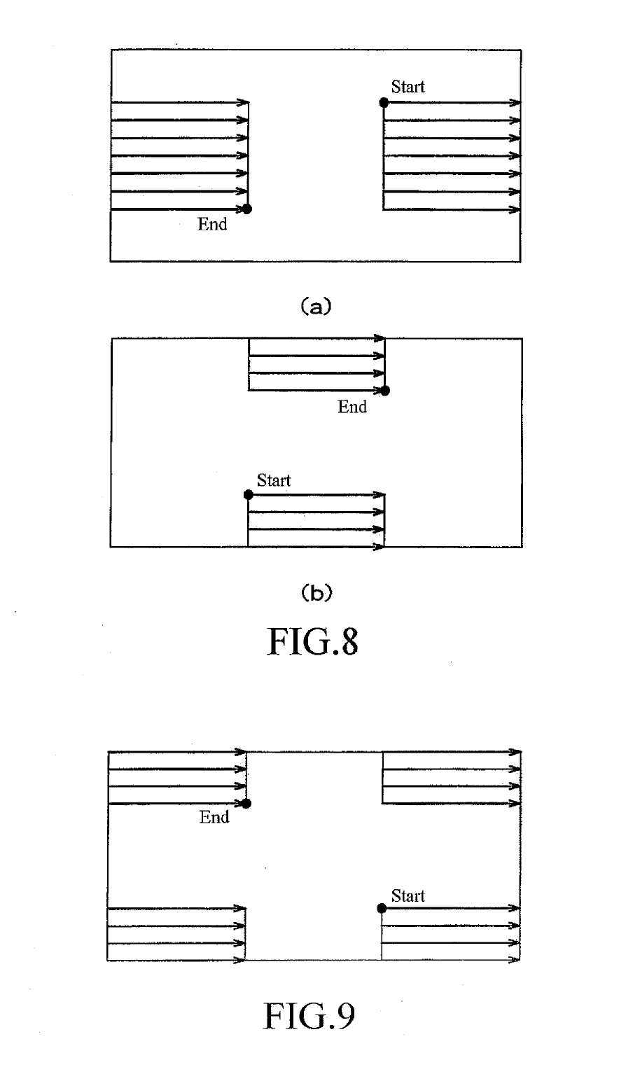

FIGS. 7 and 8 show the “spilt” of the left-right or upper-bottom divided display areas.

FIG. 7(a) shows the divided display areas occupy the left and right parts of the entire display, where the areas could be defined by the X coordinate of the most upper-left point of the right part as the start and the X coordinate of the most bottom-right point of the left part as the end. Likewise, FIG. 7(b) shows the divided display areas occupy the upper and bottom parts of the entire display, where the area could be defined by the Y coordinate of the most upper-left point of the bottom part as the start and the Y coordinate of the most bottom-right point of the upper part as the end.

In FIG. 8(a), the divided display areas have the left part and the right part and both parts have the same limited height. Therefore, the divided display areas could be defined by the most upper-left point of the right part as the start and the most bottom-right point of the left part as the end. Likewise, in FIG. 8(b), the divided display area has the upper part and the bottom part and both parts have the same limited width. Therefore, the divided display areas could be defined by the most upper-left point of the bottom part as the start and the most bottom-right point of the upper part as the end.

FIG. 9 the divided display areas occupy the four corner parts of the entire display. The two upper corner parts have the same bottom line, the two bottom corner parts have the same upper line, the two left corner parts have the same right line, and the two right corner parts have the same lift line. Therefore the divided display areas could be defined by the most upper-left point of the bottom-left corner part as the start and the most bottom-right point of the upper-right corner part as the end.

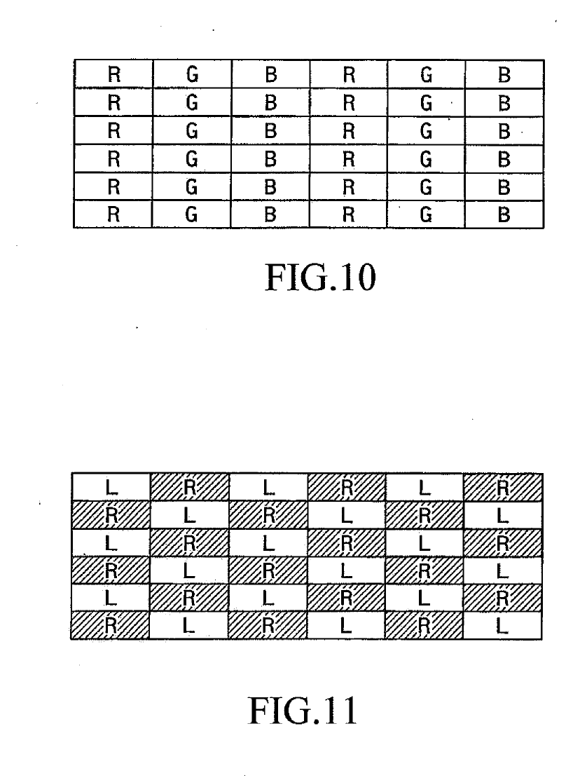

FIG. 10 shows the arrangement of the pixels in the LCD display 6. Red (R) pixels, green (G) pixels, and blue (B) pixels are arranged in alternative strip fashion repeated in the horizontal direction.

Corresponding to the pixel arrangement in FIG. 10, FIG. 11 shows the R divided display areas for the right view and the L divided display area for the left view, which are interlaced horizontally and vertically. Therefore, according to the present invention, division of display area is defined as dividing one display by a unit of pixel(s) (or sub-pixel(s)) and enabling visual perception from a plurality of viewpoints.

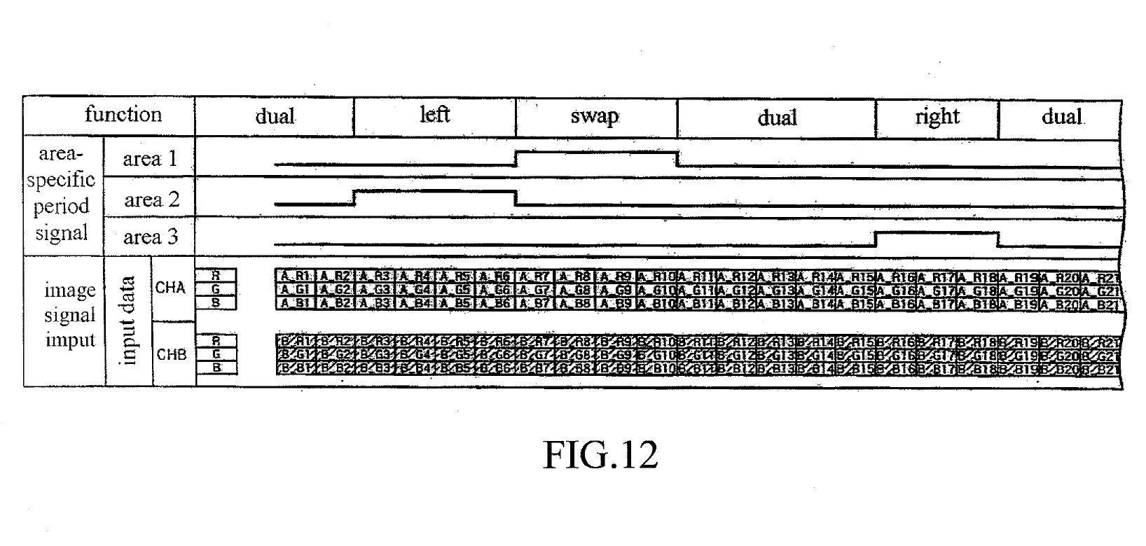

The following FIGS. 12-14 are to illustrate the actions of the embodiment of the present invention.

FIG. 12 shows the area-specific period signals from the area-specific period pulse generating circuit 54 (shown in FIG. 3). For respective divided display area, the function selection circuit 530-53N selects one of the four functions provided by the function signal generating circuit 52. In this embodiment, the divided display area 1 is assigned to the “swap function”, the divided display area 2 is assigned to the “left function”, the divided display area 3 is assigned to the “right function”, and areas out of the divided display areas (e.g., the background area) are assigned to the normal dual function.

Outputs of Selection circuits 530-53N are inputted to the corresponding switches SW550-55N of the area selection circuit 55. These switches SW550-55N turn ON or Off according to the area-specific period signals from the area-specific period pulse generating circuit 54. For the background display area out of the divided display areas, the switch SW550 could be controlled in the default setting.

As shown in FIG. 12, the image signals are supplied from Channel A or Channel B. Therefore, according to the timing selected by the area-specific period signals, one of the image signals A and B are selected and sent to the flip-flop 58 for timing stabilization. Then the flip-flop 58 will generate the image signal C and send to the display 6.

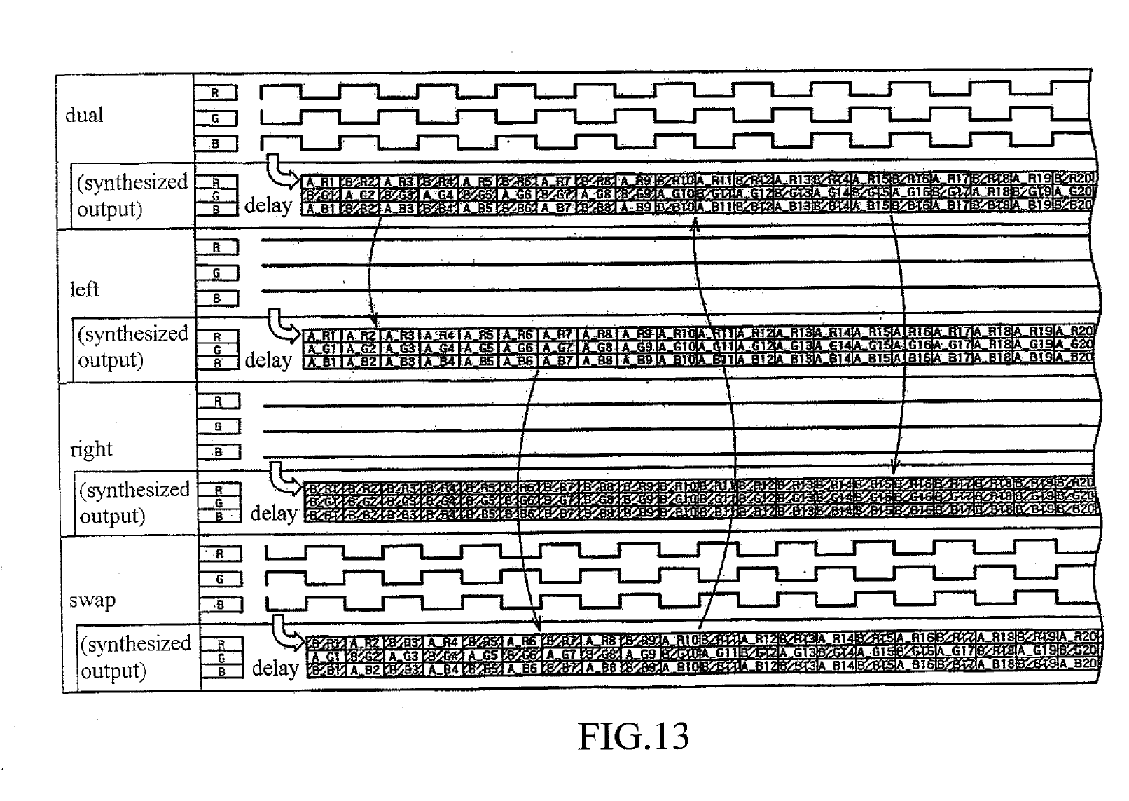

FIG. 13 shows the synthesis of the RGB signals of Channels A and B according to respective functions. As shown in FIG. 13, for the left function (Function 2), all signals from Channel A are read out; for the right function (Function 3), all signals from Channel B are read out. But for the dual function (Function 1) and the swap function (Function 4), signals from Channel A and Channel B are alternatively read out by every half period. And the signals read out from Channel A (or Channel B) in the dual function (Function 1) is changed to the signal read out from Channel B (or Channel A) in the swap function (Function 4), and vice versa.

Also as shown in FIG. 13, compared to the function signals, the actual output signal will be delayed due to some timing adjustments.

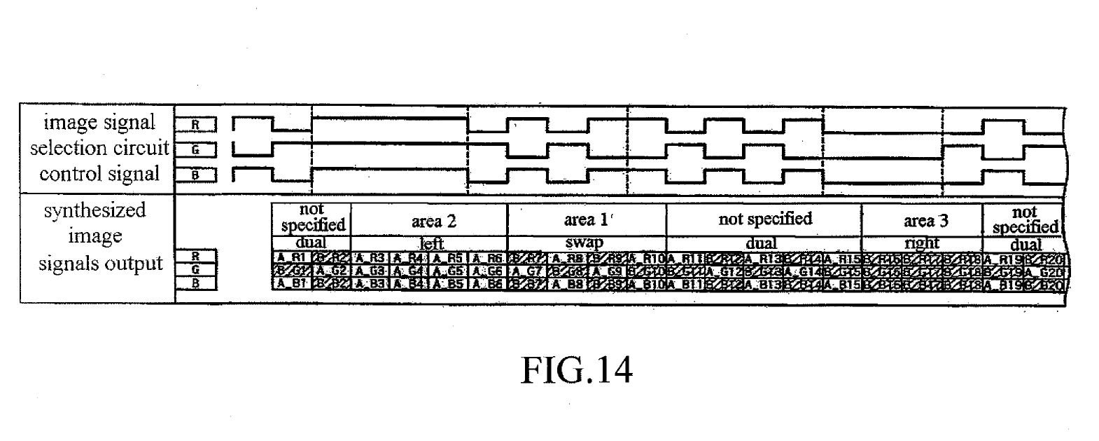

FIG. 14 compares the control signal from the image signal selection circuit 56 with the synthesized images. Following the arrows in FIG. 3, the image signals are synthesized according to the selected functions.

In this manner, according to the control signal, the coordinate data, and the function selection data from the microprocessor 1, the left and the right divided display area respectively provides images in the left and the right view according to the selected functions. Therefore, any part of the any divided display area (i.e., the partial display area) for any view can be set in high freedom for an object to be commonly shown. Moreover, the display mode of object could be selected by different functions. Therefore, the image signals A and B from the images sources 2 and 3 could be synthesized and shown in different combinations in high freedom.

For example, in Japanese Patent Publication 2007-11061A, image signal for the traffic information (or TV channel selection buttons, or navigation image) was shown in only one view. With the present invention, the image signal can be commonly presented in the left and the right view by the specific divided display areas. Also OSD object/information can be commonly presented in the left and the right view by the specific divided display areas. And preferably, the specific divided display areas can equip with the touch sensing function.

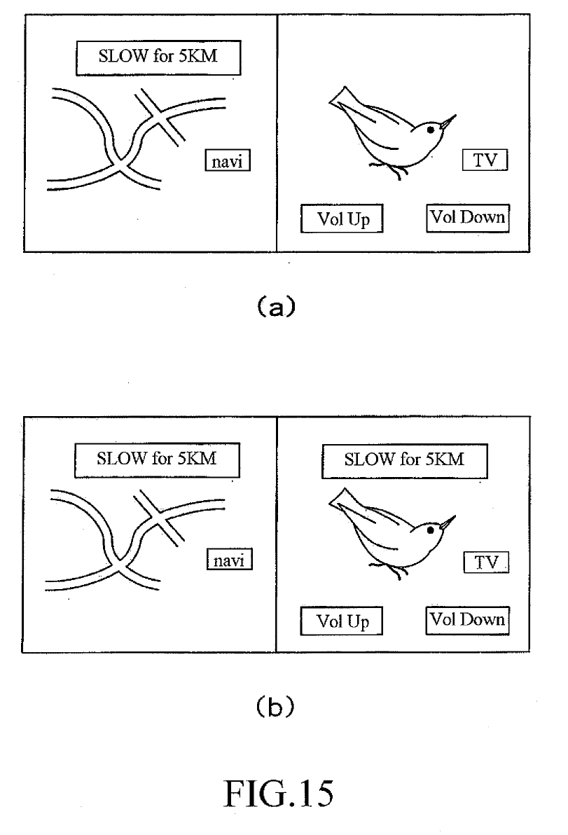

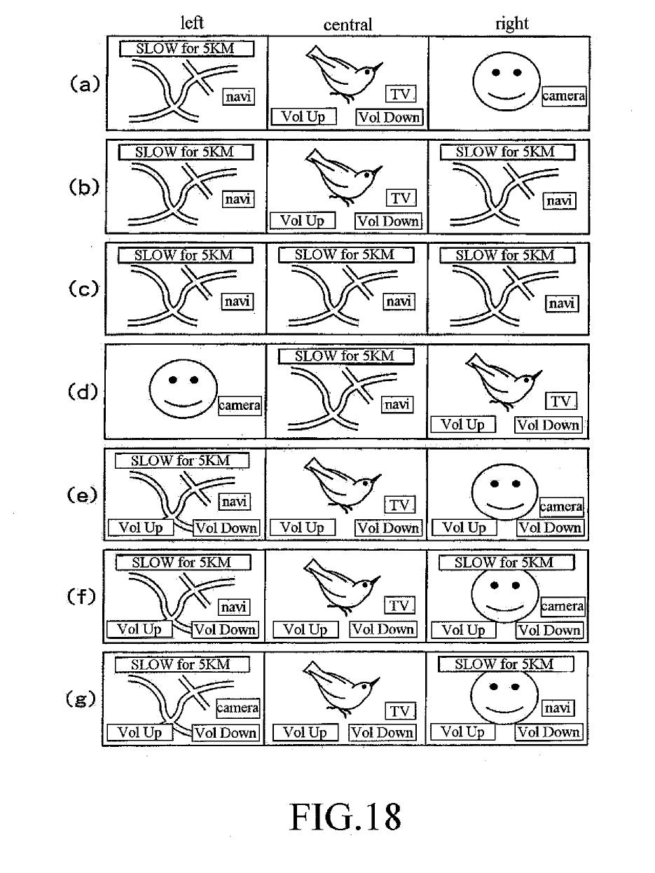

The following FIGS. 15-16 and 18 show the left view, the right view, and the middle view (FIG. 18). Note that the different views are provided by the different divided display areas on the same display 6. To explain an embodiment of the present invention, the left view is represented by the left divided display area, and the right view is represented by the right divided display area, where the left and the right divided display areas could be referred to FIG. 11.

According to the conventional art, in FIG. 15(a), on one hand, traffic information is displayed only in the upper partial display area of the left divided display area where the car navigation image is also displayed. On the other hand, a touch switch for adjusting volume of TV sound is displayed only in the lower partial display area of the right divided display area where TV image is displayed. Display mode in FIG. 15(a) can be changed to the display mode in FIG. 15(b) where object image of the traffic information is shared and commonly shown by partial display areas.

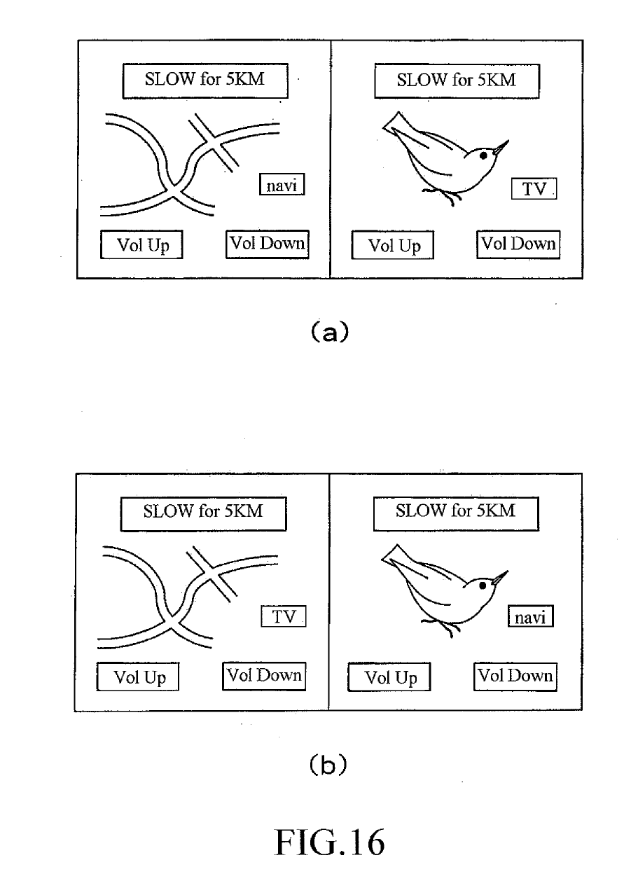

By contrast, in the dual view display apparatus according to the present invention, since traffic information is necessary information for both the driver and a passenger in the front seat, for the partial display area for the traffic information, function 2 (in FIG. 4) is selected by the function selection circuit 53, and for the partial display area for the volume adjusting of TV sound, function 3 (in FIG. 4) is selected, As a result, the two object images (traffic information and volume buttons) provided by different image signals (CHA ` CHB) are commonly displayed in the partial display areas in the left and right divided display areas as shown in FIG. 16(a). Furthermore, as shown in FIG. 16(b) in order to confirm images in opposite side, object images (“navi” indication and “TV” indication) originally in respective views are exchanged right and left by swapping function.

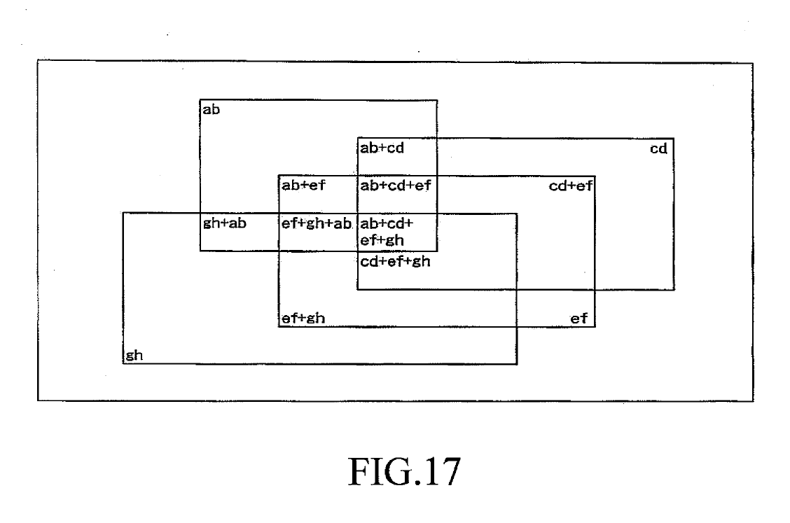

Furthermore, the partial display areas can be arbitrarily set in each of the divided display area, and two or more partial display areas could be overlapped. In this situation, the overlapped part could be deemed a new individual partial display area, and display mode could be individually set for the overlapped area individually as a separate partial display area. As shown in FIG. 17, the four partial areas ab, cd, ef, gh have two-layer overlapped parts ab+cd, ab+ef, a three-layer overlapped parts ab+cd+ef, and a four-layer overlapped part ab+cd+ef+gh. These overlapped parts could be regarded as the individual partial display area and the display functions (shown in FIG. 4) of them could be separately set. Moreover, the overlap of the partial display areas could extend to the combination part of the partial display areas or the difference part among the partial display area.

Moreover, by the selection of the functions in FIG. 4, the display could set the partial display area for the images to be commonly presented or swapped. These features are called Partial Selected View (PSV).

For example, the display area is divided into a first and a second divided display areas, e.g., the left and the right. These areas are visible from respective different viewpoints. Similar to FIG. 14, the allocator 5 (in FIG. 2) performs synthesis of image data for divided display areas using a first and a second image data (e.g., image signals A for navigation and image signals B for TV) externally and separately input into one of the following combination modes:

the first image data for the first divided display area and the second image data for the second divided display area;

the first image data for the first divided display area and the first image data for the second divided display area;

the second image data for the first divided display area and the second image data for the second divided display area; and

the second image data for the first divided display area and the first image data for the second divided display area.

In another embodiment, the first divided display area has a first partial display area set therein, and the second divided display area has a second partial display area set therein. The allocator 5 (in FIG. 2) performs synthesis of image data for divided display areas using a first and a second partial image data (e.g., image signals A for traffic information and image signals B for volume buttons) externally and separately input into one of the following combination modes:

the first partial image data for the first partial display area and the second partial image data for the second partial display area,

the first partial image data for the first partial display area and the first partial image data for the second partial display area,

the second partial image data for the first partial display area and the second partial image data for the second partial display area, and

the second partial image data for the first partial display area and the first partial image data for the second partial display area.

The embodiments above are related to the dual view display apparatus. Those skilled in the art should understand that the present invention can apply to the multi view display apparatus enabling more than two views, and the functions for the object images or the divided display areas can be set corresponding to the multiple views, as shown in the following FIGS. 18(a)-(g), wherein the image in each view is presented by the corresponding divided display area of the same display 6.

For example, FIG. 18(a) shows the images in three views provided by the multi view display apparatus according to an embodiment, i.e., the left view for the driver, the right view for the passenger in the front seat, and the middle view for the passenger in the back seat. In this embodiment, the navigation image is presented in the left view for the driver, the camera image is presented in the right view for the passenger in the front seat, and the TV image is presented in the middle view for the passenger in the back seat.

By contrast, in FIG. 18(b), the navigation image is presented in the left view for the driver and in the right view for the passenger in the front seat; in FIG. 18(c), the navigation image is presented in the left view for the driver, in the right view for the passenger in the front seat, and in the middle view for the passenger in the back seat. Then in FIG. 18(d), images in each view could be exchanged, so that the camera image will be in the left view for the driver, the TV image will be in the right view for the passenger in the front seat, and the navigation image will be in the middle view for the passenger in the back seat.

Then in FIG. 18(e), TV image in the middle view originally has volume buttons, and the display areas of the volume buttons are equipped with the touch sense capability. Then the volume button could be commonly presented in the left view with the navigation image and in the right view with the camera image. Alternatively, in FIG. 18(f), the traffic information could be commonly presented in the left view with the navigation image and in the right view with the camera image, but not in the middle view with the TV image. Moreover, in FIG. 18(g), the “navi” indication originally in the left view and the “camera” indication originally in the right view could be swapped, so that now the “navi” indication is shown in the right view with the camera image and the “camera” indication is shown in the left view with the navigation image.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

We claim:

1. A multi view display apparatus comprising:
a display whose display area comprising a plurality of divided display areas, the divided display areas being visible from respective different view points and each divided display area having at least one partial display area;
a data generator to generate coordinate data for indicating the divided display areas and the partial display areas in the divided display areas, and to generate display mode data to designate display modes of the divided display areas and of the partial display areas; and
an allocator to synthesize a plurality of input image data to obtain a synthesized image by allocating the plurality of input image data in views of the divided display areas and of the partial display areas in the divided display areas.

2. The multi-view display apparatus according to claim 1, wherein the partial display area is an area for displaying information common to respective viewers of the divided display areas.

3. The multi-view display apparatus according to claim 2, wherein the partial display area has a touch panel sensor function.

4. The multi-view display apparatus according to claim 1, wherein the data generator generates the display mode data relating to normal display mode, swapped display mode and common display mode for the divided display areas and for the partial display areas, the display mode data being derived based on a synchronization signal under an instruction from a microprocessor which controls the overall display apparatus.

5. The multi-view display apparatus according to claim 1, wherein the display area has a first and a second divided display areas, these divided areas are visible from respective different viewpoints, and the allocator obtains the synthesized image at least by synthesizing image data from a first and a second image data, externally and separately inputted, in one of the following combination modes:
the first image data for the first divided display area and the second image data for the second divided display area,
the first image data for the first divided display area and the first image data for the second divided display area,
the second image data for the first divided display area and the second image data for the second divided display area, and
the second image data for the first display area and the first image data for the second divided display area.

6. The multi-view display apparatus according to claim 5, wherein the first divided display area further comprises a first partial display area and the second divided display area further comprises a second partial display area, and wherein the allocator obtains the synthesized image at least by synthesizing image data from a first and a second partial image data, externally and separately inputted, in one of the following combination modes:
the first partial image data for a the partial display area and the second partial image data for the second partial display area,
the first partial image data for the first partial display area and the first partial image data for the second partial display area,
the second partial image data for the first partial display area and the second partial image data for the second partial display area, and
the second partial image data for the first partial display area and the first partial image data for the second partial display area.

7. The multi-view display apparatus according to claim 6, wherein a plurality of partial display areas can be provided in each divided display area.

8. The multi-view display apparatus according to claim 7, wherein when the plurality of partial display areas are overlapped, the display mode is individually set for the overlapped area as a separate partial display area.

9. The multi-view display apparatus according to claim 1, wherein the display area is divided into 3 or more divided display areas, and the allocator allocates the same image data or arbitrary swapped supplied image data to the divided display areas.

10. The multi-view display apparatus according to claim 9, wherein the same image data and arbitrary swapped supplied image data can be synthesized for the partial display areas in the arbitrary divided display areas.

11. The multi-view display apparatus according to claim 1, wherein the partial display area has a touch panel sensor function.

12. The multi-view display apparatus according to claim 1, wherein the display area has a first and a second divided display areas, these divided areas are visible from respective different viewpoints, the first divided display area further comprises a first partial display area and the second divided display area further comprises a second partial display area, and wherein the allocator obtains the synthesized image at least by synthesizing image data from a first and a second partial image data, externally and separately inputted, in one of the following combination modes:
the first partial image data for a the partial display area and the second partial image data for the second partial display area,
the first partial image data for the first partial display area and the first partial image data for the second partial display area,
the second partial image data for the first partial display area and the second partial image data for the second partial display area, and
the second partial image data for the first partial display area and the first partial image data for the second partial display area.

13. The multi-view display apparatus according to claim 12, wherein a plurality of partial display areas can be provided in each divided display area.

14. The multi-view display apparatus according to claim 13, wherein when the plurality of partial display areas are overlapped, the display mode is individually set for the overlapped area as a separate partial display area.
